(19) United States
(12) Patent Application Publication
(10) Pub. No.: US 2022/0169163 A1
(43) Pub. Date: Jun. 2, 2022

(54) Impermeable Barrier Assembly

(71) Applicant: Kalen Parker, Paducah, KY (US)

(72) Inventor: Kalen Parker, Paducah, KY (US)

(21) Appl. No.: 17/108,131

(22) Filed: Dec. 1, 2020

(51) Int. Cl. B60N 2/90

(52) U.S. Cl. CPC B60N 2/91

(57) ABSTRACT

An impermeable barrier assembly includes a panel that is mountable on a golf cart to extend between occupants of the golf cart. The panel is comprised of a fluid impermeable material to inhibit transmission of infectious diseases between the occupants. A first cord is provided that releasably engages the panel thereby facilitating the first cord to be extended over the roof of the golf cart. A second cord is provided that releasably the panel and an undercarriage of the golf cart having the second cord extending over a front end of the golf cart. A third cord is provided that releasably engages the panel and a structural feature on the golf cart having the third cord extending beneath the backrest of the seat of the golf cart.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to barrier devices and more particularly pertains to a new barrier device for inhibiting transmission of infectious disease between occupants of a golf cart. The barrier device is positionable between occupants of a vehicle with an open air cabin in a non-permanent fashion. Additionally, the barrier device is translucent to facilitate the occupants of the vehicle to see one another.

### (2) Description of Related Art Including Information Disclosed Under 37 CFR 1.97 and 1.98

The prior art relates to barrier devices including a variety of barriers which can be mounted to a roof frame of a golf cart to completely surround the golf cart. The prior art discloses a variety of partitions that can be positioned within a vehicle, which has an enclosed cabin, and which is positionable between occupants of the vehicle. In no instance does the prior art disclose a barrier that is removably positionable between occupants of a golf cart and which includes resiliently stretchable cords for mounting the barrier to the golf cart.

### BRIEF SUMMARY OF THE INVENTION

An embodiment of the disclosure meets the needs presented above by generally comprising a panel that is mountable on a golf cart to extend between occupants of the golf cart. The panel is comprised of a fluid impermeable material to inhibit transmission of infectious diseases between the occupants. A first cord is provided that releasably engages the panel thereby facilitating the first cord to be extended over the roof of the golf cart. A second cord is provided that releasably the panel and an undercarriage of the golf cart having the second cord extending over a front end of the golf cart. A third cord is provided that releasably engages the panel and a structural feature on the golf cart having the third cord extending beneath the backrest of the seat of the golf cart.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of an impermeable barrier assembly according to an embodiment of the disclosure.

FIG. 2 is a right side view of panel of an embodiment of the disclosure.

FIG. 3 is a left side view of a panel of an embodiment of the disclosure.

FIG. 4 is a detail view of mating unit engaging a first grommet of an embodiment of the disclosure.

FIG. 5 is a perspective in-use view of an embodiment of the disclosure.

### DETAILED DESCRIPTION OF THE INVENTION

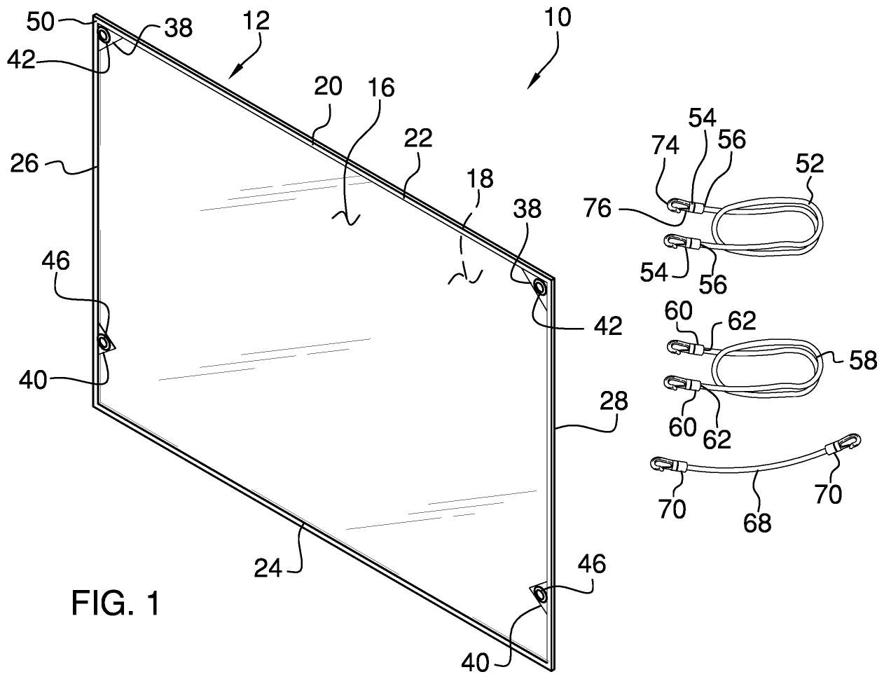

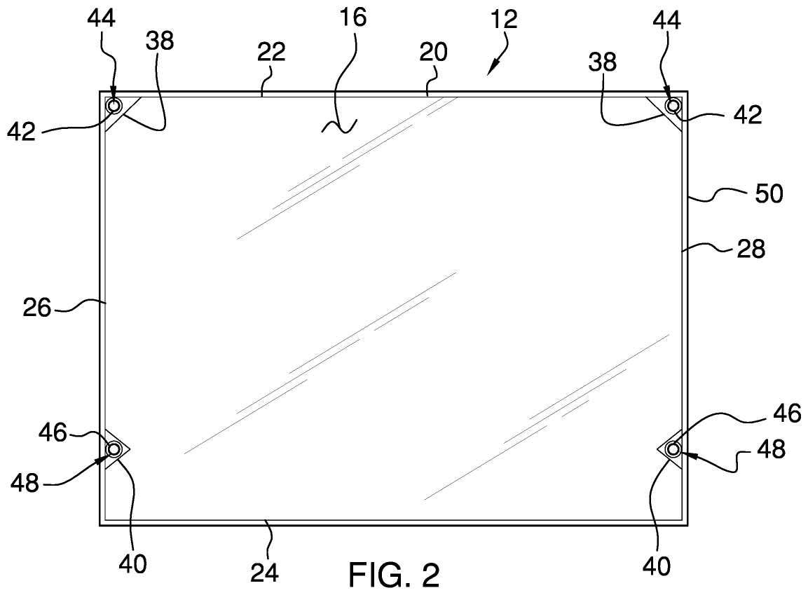

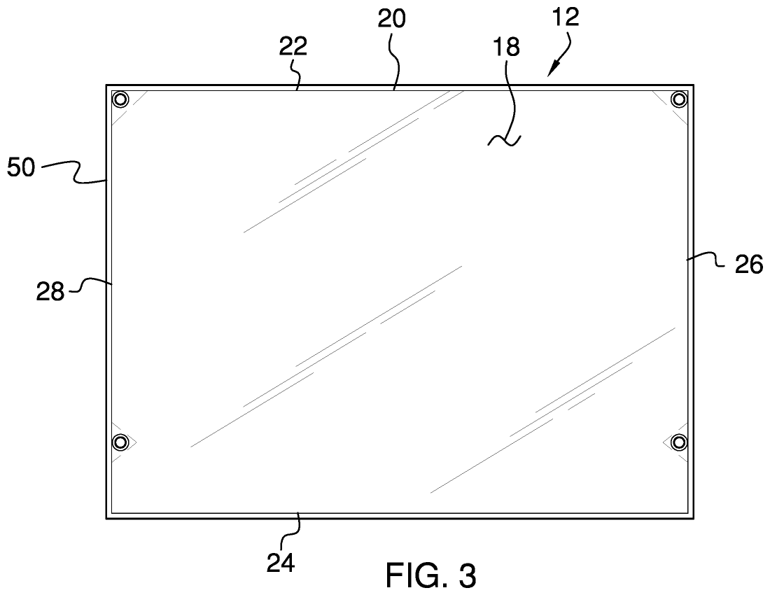

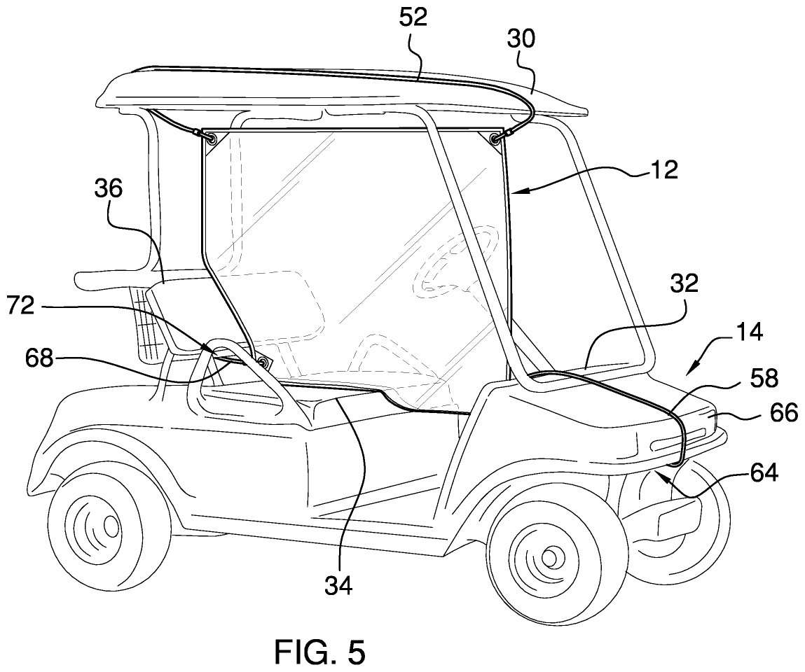

With reference now to the drawings, and in particular to FIGS. 1 through 5 thereof, a new barrier device embodying the principles and concepts of an embodiment of the disclosure and generally designated by the reference numeral 10 will be described.

As best illustrated in FIGS. 1 through 5, the impermeable barrier assembly 10 generally comprises a panel 12 that is mountable on a golf cart 14 such that the panel 12 can extend between occupants of the golf cart 14. The panel 12 is comprised of a fluid impermeable material to inhibit transmission of infectious diseases between the occupants. Additionally, the panel 12 is comprised of a translucent material to pass light therethrough thereby facilitating the occupants to see each other. The golf cart 14 may be an electric golf cart, a gas powered golf cart or any other type of golf cart. Additionally, the panel 12 can be positioned in any type of open air vehicle that has accommodations for at least two occupants.

The panel 12 has a first surface 16, a second surface 18 and a perimeter edge 20 extending therebetween. The perimeter edge 20 has a top side 22, a bottom side 24, a first lateral side 26 and a second lateral side 28. Each of the top side 22 and the bottom side 24 has an equal length, and each of the first lateral side 26 and the second lateral side 28 has an equal length. Each of the top side 22 and the bottom side 24 has a greater length that the first lateral side 26 and the second lateral side 28.

The panel 12 is oriented such that each of the first surface 16 and the second surface 18 lies on a horizontal plane having the top side 22 being positioned adjacent to a roof 30 of the golf cart 14. Additionally, the panel 12 is oriented such that the first lateral side 26 is positioned adjacent to a dashboard 32 of the golf cart 14. The panel 12 is oriented such that the bottom side 24 extends across a seat 34 of the golf cart 14 and the panel 12 is oriented such that the second lateral side 28 extends upwardly along a backrest 36 of the seat 34 of the golf cart 14.

A pair of first gussets 38 is provided and each of the first gussets 38 is integrated into the panel 12. Each of the first gussets 38 is comprised of a rip resistant material such that each of the first gussets 38 reinforces the panel 12. Each of the first gussets 38 extends through the first surface 16 and the second surface 18 of the panel 12. Moreover, each of the first gussets 38 is aligned with an intersection between the top side 22 of the perimeter edge 20 and a respective one of the first lateral side 26 and the second lateral side 28 of the perimeter edge 20.

A pair of second gussets 40 is each integrated into the panel 12 and each of the second gussets 40 is comprised of a rip resistant material such that each of the second gussets 40 reinforces the panel 12. Each of the second gussets 40 extends through the first surface 16 and the second surface 18, and each of the second gussets 40 is positioned adjacent to a respective one of the first lateral side 26 and the second lateral side 28 of the perimeter edge 20. Moreover, each of the second gussets 40 is spaced from the bottom side 24 of the perimeter edge 20, and each of the second gussets 40 is aligned with each other.

A pair of first grommets 42 is provided and each of the first grommets 42 extends through a respective one of the first gussets 38 such that each of the first grommets 42 defines a hole 44 extending through the panel 12. A pair of second grommets 46 is provided and each of the second grommets 46 extends through a respective one of the second gussets 40 such that each of the second grommets 46 defines a hole 48 extending through the panel 12. A border 50 is integrated into the panel 12 and the border 50 extends around each of the top side 22, the bottom side 24, the first lateral side 26 and the second lateral side 28 of the perimeter edge 20 of the panel 12. The border 50 has a thickness that is greater than a thickness of the panel 12 between the first surface 16 and the second surface 18.

A first cord 52 is provided which has a pair of mating units 54 that is each coupled to opposite ends 56 of the first cord 52. Each of the mating units 54 releasably engages a respective one of the first grommets 42 thereby facilitating the first cord 52 to be extended over the roof 30 of the golf cart 14. Moreover, the first cord 52 is comprised of a resiliently stretchable material thereby facilitating the first cord 52 to accommodate a variety of lengths of roofs. A second cord 58 is provided which has a pair of mating units 60 that is each coupled to opposite ends 62 of the second cord 58. A respective one of the mating units 60 on the second cord 58 releasably engages a respective one of the second grommets 46. Additionally, a respective one of the mating units 60 on the second cord 58 engages an undercarriage 64 of the golf cart 14 has the second cord 58 extending over a front end 66 of the golf cart 14. The second cord 58 is comprised of a resiliently stretchable material thereby facilitating the second cord 58 to accommodate a variety of dimensions of front ends of golf carts.

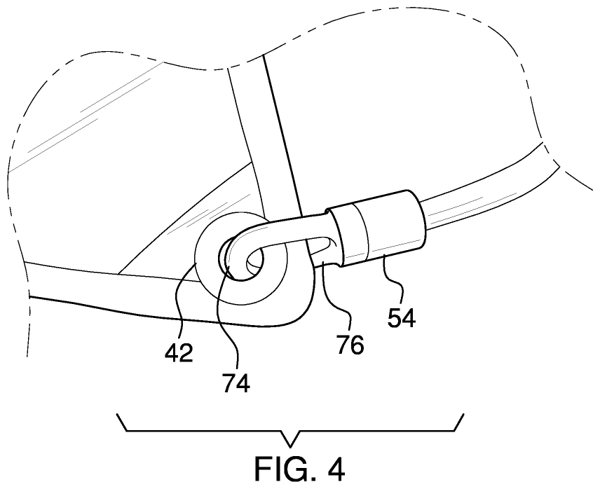

A third cord 68 is provided which has a pair of mating units 70 that is each is coupled to opposite ends 72 of the third cord 68. A respective one of the mating units 70 on the third cord 68 releasably engages a respective one of the second grommets 46. Additionally, a respective one of the mating units 70 on the third cord 68 engages a structural feature 72 on the golf cart 14 having the third cord 68 extending beneath the backrest 36 of the seat 34 of the golf cart 14. The third cord 68 is comprised of a resiliently stretchable material thereby facilitating the third cord 68 to accommodate a variety of dimensions of the structural features with respect to the backrest 36. As is most clearly shown in FIG. 4, each of the mating units 54, 60, 70 on the first cord 52, the second cord 58 and the third cord 68 may comprise a curved member 74 that forms a hook which can be extended through the respective first grommets 42 and second grommets 46. Additionally, each of the mating units 54, 60, 70 may include a movable closure 76 that engages the curved member 74 to inhibit the mating units 54, 60, 70 from being inadvertently removed from the respective first grommets 42 and second grommets 46.

In use, the panel 12 is positioned in the golf cart 14 such that the panel 12 bisects the seat 34 in the golf cart 14. In this way the panel 12 forms a fluid impermeable barrier between occupants of the golf cart 14. Thus, the panel 12 inhibits the transmission of infectious diseases between the occupants during a pandemic or the like. Each of the mating units 54 on the first cord 52 is coupled to respective first grommets 42 and the first cord 52 is extended across the roof 30 of the golf cart 14. Each of the mating units 60 on the second cord 58 is coupled to a respective second grommet 46 and the undercarriage 64 of the golf cart 14, respectively, such that the second cord 58 extends over the front end 66 of the golf cart 14. Each of the mating units 70 on the third cord 68 is coupled to a respective second grommet 46 and the structural feature 72, respectively, such that the third cord 68 extends beneath the backrest 36 of the seat 34.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. An impermeable barrier assembly for mounting between occupants in a golf cart to inhibit the transmission of infectious diseases between the occupants, said assembly comprising:
a panel being mountable on a golf cart wherein said panel is configured to extend between occupants of the golf cart, said panel being comprised of a fluid impermeable material wherein said panel is configured to inhibit transmission of infectious diseases between the occupants, said panel being comprised of a translucent material wherein said panel is configured to pass light therethrough thereby facilitating the occupants to see each other, wherein said panel has a first surface, a second surface and a perimeter edge extending therebetween, said perimeter edge having a top side, a bottom side, a first lateral side and a second lateral side, each of said top side and said bottom side having an equal length, each of said first lateral side and said second lateral side having an equal length, each of said top side and said bottom side having a greater length that said first lateral side and said second lateral side;
a pair of first gussets, each of said first gussets being integrated into said panel, each of said first gussets being comprised of a rip resistant material such that each of said first gussets reinforces said panel;
a pair of second gussets, each of said second gussets is integrated into said panel, each of said second gussets being comprised of a rip resistant material such that each of said second gussets reinforces said panel;
a pair of first grommets, each of said first grommets extending through a respective one of said first gussets such that each of said first grommets defines a hole extending through said panel;
a pair of second grommets, each of said second grommets extending through a respective one of said second gussets such that each of said second grommets defines a hole extending through said panel, wherein each of said second gussets is positioned on said first surface, each of said second gussets being positioned adjacent to a respective one of said first lateral side and said second lateral side of said perimeter edge, each of said second gussets being spaced from said bottom side of said perimeter edge, each of said second gussets being aligned with each other;
a first cord having a pair of mating units each being coupled to opposite ends of said first cord, each of said mating units releasably engaging a respective one of said first grommets thereby facilitating said first cord to be extended over the roof of the golf cart;
a second cord having a pair of mating units each being coupled to opposite ends of said second cord, a respective one of said mating units on said second cord releasably engaging a respective one of said second grommets, a respective one of said mating units on said second cord engaging an undercarriage of the golf cart having said second cord extending over a front end of the golf cart; and
a third cord having a pair of mating units each being coupled to opposite ends of said third cord, a respective one of said mating units on said third cord releasably engaging a respective one of said second grommets, a respective one of said mating units on said third cord engaging a structural feature on the golf cart having said third cord extending beneath the backrest of the seat of the golf cart.

2. (canceled)

3. The assembly according to claim 1, wherein said panel is oriented such that each of said first surface and said second surface lies on a horizontal plane having said top side being positioned adjacent to a roof of the golf cart, said panel being oriented such that said first lateral side is positioned adjacent to a dashboard of the golf cart, said panel being oriented such that said bottom side extends across a seat of the golf cart, said panel being oriented such that said second lateral side extends upwardly along a backrest of the seat of the golf cart.

4. The assembly according to claim 1, wherein each of said first gussets is positioned on said first surface of said panel, each of said first gussets being aligned with an intersection between said top side of said perimeter edge and a respective one of said first lateral side and said second lateral side of said perimeter edge.

5. (canceled)

6. The assembly according to claim 1, further comprising a border being integrated into said panel, said border extending around each of said top side, said bottom side, said first lateral side and said second lateral side of said perimeter edge of said panel, said border having a thickness being greater than a thickness of said panel between said first surface and said second surface.

7. An impermeable barrier assembly for mounting between occupants in a golf cart to inhibit the transmission of infectious diseases between the occupants, said assembly comprising:
a panel being mountable on a golf cart wherein said panel is configured to extend between occupants of the golf cart, said panel being comprised of a fluid impermeable material wherein said panel is configured to inhibit transmission of infectious diseases between the occupants, said panel being comprised of a translucent material wherein said panel is configured to pass light therethrough thereby facilitating the occupants to see each other, said panel having a first surface, a second surface and a perimeter edge extending therebetween, said perimeter edge having a top side, a bottom side, a first lateral side and a second lateral side, each of said top side and said bottom side having an equal length, each of said first lateral side and said second lateral side having an equal length, each of said top side and said bottom side having a greater length that said first lateral side and said second lateral side, said panel being oriented such that each of said first surface and said second surface lies on a horizontal plane having said top side being positioned adjacent to a roof of the golf cart, said panel being oriented such that said first lateral side is positioned adjacent to a dashboard of the golf cart, said panel being oriented such that said bottom side extends across a seat of the golf cart, said panel being oriented such that said second lateral side extends upwardly along a backrest of the seat of the golf cart;
a pair of first gussets, each of said first gussets being integrated into said panel, each of said first gussets being comprised of a rip resistant material such that each of said first gussets reinforces said panel, each of said first gussets is positioned on said first surface of said panel, each of said first gussets being aligned with an intersection between said top side of said perimeter edge and a respective one of said first lateral side and said second lateral side of said perimeter edge;
a pair of second gussets, each of said second gussets being integrated into said panel, each of said second gussets being comprised of a rip resistant material such that each of said second gussets reinforces said panel, each of said second gussets is positioned on said first surface, each of said second gussets being positioned adjacent to a respective one of said first lateral side and said second lateral side of said perimeter edge, each of said second gussets being spaced from said bottom side of said perimeter edge, each of said second gussets being aligned with each other;
a pair of first grommets, each of said first grommets extending through a respective one of said first gussets such that each of said first grommets defines a hole extending through said panel;
a pair of second grommets, each of said second grommets extending through a respective one of said second gussets such that each of said second grommets defines a hole extending through said panel;
a border being integrated into said panel, said border extending around each of said top side, said bottom side, said first lateral side and said second lateral side of said perimeter edge of said panel, said border having a thickness being greater than a thickness of said panel between said first surface and said second surface;
a first cord having a pair of mating units each being coupled to opposite ends of said first cord, each of said mating units releasably engaging a respective one of said first grommets thereby facilitating said first cord to be extended over the roof of the golf cart, said first cord being comprised of a resiliently stretchable material wherein said first cord is configured to accommodate a variety of lengths of roofs;
a second cord having a pair of mating units each being coupled to opposite ends of said second cord, a respective one of said mating units on said second cord releasably engaging a respective one of said second grommets, a respective one of said mating units on said second cord engaging an undercarriage of the golf cart having said second cord extending over a front end of the golf cart, said second cord being comprised of a resiliently stretchable material wherein said second cord is configured to accommodate a variety of dimensions of front ends of golf carts; and
a third cord having a pair of mating units each being coupled to opposite ends of said third cord, a respective one of said mating units on said third cord releasably engaging a respective one of said second grommets, a respective one of said mating units on said third cord engaging a structural feature on the golf cart having said third cord extending beneath the backrest of the seat of the golf cart, said third cord being comprised of a resiliently stretchable material wherein said third cord is configured to accommodate a variety of dimensions of the structural features with respect to the backrest.
